(19) United States
(12) Patent Application Publication
(10) Pub. No.: US 2016/0140477 A1
(43) Pub. Date: May 19, 2016

(54) METHODS AND SYSTEMS FOR ASSIGNING TASKS TO WORKERS

(71) Applicant: XEROX CORPORATION, Norwalk, CT (US)

(72) Inventors: Saraschandra Karanam, Bangalore (IN); Laura Elisa Celis, St. Sulpice (CH); VAIBHAV RAJAN, Bangalroe (IN); Koustuv Dasgupta, Bangalore (IN); Deepthi Chander, Cochin (IN)

(21) Appl. No.: 14/540,203

(22) Filed: Nov. 13, 2014

(51) Int. Cl. G06Q 10/06

(52) U.S. Cl. CPC G06Q 10/063112

(57) ABSTRACT

The disclosed embodiments illustrate methods and systems for assigning one or more tasks to a labor channel from one or more labor channels. The method includes selecting a first labor channel from said one or more labor channels based at least on a distribution of a performance metric associated with each of said one or more labor channels. The first labor channel is selected for execution of said one or more tasks. The method includes updating said distribution of said performance metric associated with each of said one or more labor channels. The method further includes selecting a second labor channel from said one or more labor channels based at least on a comparison between said updated distribution of said performance metric associated with said first labor channel, and said updated distribution of said performance metric associated with remaining one or more labor channels.

### TECHNICAL FIELD

The presently disclosed embodiments are related, in general, to crowdsourcing. More particularly, the presently disclosed embodiments are related to methods and systems for assigning tasks to one or more workers.

### BACKGROUND

With the advancement of telecommunication and the penetration of internet among the masses, crowdsourcing has emerged as an opportunity for various requestors including enterprises and individuals to outsource their tasks to loosely bound groups of workers, also called crowdworkers. The requestors may crowdsource various tasks such as video/image tagging tasks, digitization of handwritten documents, content generation, and so on, to the crowdworkers through one or more crowdsourcing platforms. The crowdworkers may then perform the tasks posted on the one or more crowdsourcing platforms.

Most of the crowdsourcing platforms may group the one or more crowdworkers based on the location of the workers and skill sets associated with the one or more crowdworkers. Hereinafter, such groups of crowdworkers have been referred as labor channels. The performance of such labor channels may vary during span of the day because of various reasons such as, but not limited to, availability of the one or more workers in the labor channels, and motivation of the one or more workers in the labor channels. Such variations in the performance may be undesirable as it may hamper the execution and quality of the responses of the one or more tasks (received from the one or more workers).

### SUMMARY

According to embodiments illustrated herein, there is provided a method for assigning one or more tasks to a labor channel from one or more labor channels. The method includes selecting a first labor channel from said one or more labor channels based at least on a distribution of a performance metric associated with each of said one or more labor channels. The first labor channel is selected for execution of said one or more tasks. The method further includes updating said distribution of said performance metric associated with each of said one or more labor channels based on performance of said first labor channel on execution of said one or more tasks. Further, the method includes selecting a second labor channel from said one or more labor channels based at least on a comparison between said updated distribution of said performance metric associated with said first labor channel, and said updated distribution of said performance metric associated with remaining one or more labor channels. Thereafter, the one or more tasks are assigned to said second labor channel. The method is performed by one or more processors.

According to embodiments illustrated herein, there is provided a system for assigning one or more tasks to a labor channel from one or more labor channels. The system includes one or more processors operable to select a first labor channel from said one or more labor channels based at least on a distribution of a performance metric associated with each of said one or more labor channels. The first labor channel is selected for execution of said one or more tasks. The one or more processors are further operable to update said distribution of said performance metric associated with each of said one or more labor channels based on performance of said first labor channel on execution of said one or more tasks. The one or more processors are further operable to select a second labor channel from said one or more labor channels based at least on a comparison between said updated distribution of said performance metric associated with said first labor channel, and said updated distribution of said performance metric associated with remaining one or more labor channels. Thereafter, the one or more processors are further operable to assign said one or more tasks to said second labor channel.

According to embodiments illustrated herein, there is provided a graphical user interface presented to a requestor. The graphical user interface includes a first interface, a second interface, and a third interface. The first interface includes a first input box enabling said requestor to select a performance metric of importance to said requestor. The first interface further includes a second input box enabling said requestor to input a value of a selection variable. The second interface includes a first region configured to display a distribution of said selected performance metric for each of one or more labor channels. The second interface further includes a second region configured to display a recommended labor channel from said one or more labor channels. Further, the second interface includes an input button configured to receive an input from said requestor to at least accept or reject said recommended labor channel. The third interface is displayed to said requestor based on said received input. The third interface includes a list of said one or more labor channels. The requestor may provide input to select a labor channel from said one or more labor channels.

According to embodiments illustrated herein, there is provided a computer program product for use with a computing device. The computer program product comprises a non-transitory computer readable medium, the non-transitory computer readable medium stores a computer program code for assigning one or more tasks to a labor channel from one or more labor channels. The computer program code is executable by one or more processors to select a first labor channel from said one or more labor channels based at least on a distribution of a performance metric associated with each of said one or more labor channels. The first labor channel is selected for execution of said one or more tasks. The computer program code is further executable by the one or more processors to update said distribution of said performance metric associated with each of said one or more labor channels based on performance of said first labor channel on execution of said one or more tasks. The computer program code is further executable by the one or more processors to select a second labor channel from said one or more labor channels based at least on a comparison between said updated distribution of said performance metric associated with said first labor channel, and said updated distribution of said performance metric associated with remaining one or more labor channels. Thereafter, the computer program code is further executable by the one or more processors to assign said one or more tasks to said second labor channel.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram illustrating a system environment in which various embodiments may be implemented;

FIG. 2 is a flowchart illustrating a method for assigning one or more tasks to a labor channel, in accordance with at least one embodiment;

FIG. 3 is a flowchart illustrating a method of selecting a labor channel from one or more labor channels, in accordance with at least one embodiment;

FIG. 4 is a flow diagram illustrating an example of selecting a labor channel from one or more labor channels, in accordance with at least one embodiment;

FIG. 5 is a block diagram illustrating a graphical user interface presented to a requestor, in accordance with at least one embodiment; and

FIG. 6 is a block diagram illustrating an application server, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Definitions: The following terms shall have, for the purposes of this application, the meanings set forth below.

A “task” refers to a piece of work, an activity, an action, a job, an instruction, or an assignment to be performed. Tasks may necessitate the involvement of one or more workers. Examples of the tasks may include, but are not limited to, image/video/text labelling/tagging/categorization, language translation, data entry, handwriting recognition, product description writing, product review writing, essay writing, address look-up, website look-up, hyperlink testing, survey completion, consumer feedback, identifying/removing vulgar/illegal content, duplicate checking, problem solving, user testing, video/audio transcription, targeted photography (e.g., of product placement), text/image analysis, directory compilation, or information search/retrieval.

“Crowdsourcing” refers to distributing tasks (hereinafter, also referred to as crowdsourcing tasks) by soliciting the participation of loosely defined groups of individual crowdworkers. A group of crowdworkers may include, for example, individuals responding to a solicitation posted on a certain website such as, but not limited to, Amazon Mechanical Turk, Crowd Flower, or Mobile Works.

A “crowdsourcing platform” refers to a business application, wherein a broad, loosely defined external group of people, communities, or organizations provide solutions as outputs for any specific business processes received by the application as inputs. In an embodiment, the business application may be hosted online on a web portal (e.g., crowdsourcing platform servers). Examples of the crowdsourcing platforms may include, but are not limited to, Amazon Mechanical Turk, Crowd Flower, or Mobile Works.

A “crowdworker” refers to a workforce/worker(s) that may perform one or more tasks, which generate data that contributes to a defined result. According to the present disclosure, the crowdworker(s) includes, but is not limited to, a satellite center employee, a rural business process outsourcing (BPO) firm employee, a home-based employee, or an internet-based employee. Hereinafter, the terms “crowdworker”, “worker”, “remote worker”, “crowdsourced workforce”, and “crowd” may be interchangeably used.

A “profile” refers to a set of information associated with the one or more crowdworkers. For example, the profile may include information, such as, but is not limited to, location of the crowdworkers, gender of the crowdworkers, age of the crowdworkers, hobbies of the crowdworkers, marital status of the crowdworker, educational qualification of the crowdworkers, occupation of the crowdworkers, income level of the crowdworkers, and so forth.

A “labor channel” refers to a group of workers that may perform one or more tasks. In an embodiment, the one or more workers associated with the crowdsourcing platform may be grouped based on one or more factors such as, but not limited to, profiles of the one or more workers, and skill set of the one or more workers. Hereinafter, the terms “group of crowdworkers”, “crowd labor channels”, “group of crowd labors”, “crowd labors” and “pool of workers” may be interchangeably used.

A “Performance Metric” refers to a measure of performance of the one or more workers on attempting the one or more tasks. For example, in an embodiment, the performance metric(s) may include, but is not limited to, a measure of cost, accuracy, response time, a number of active workers across spatio-temporal dimensions in a labor channel, etc.

A “Distribution” refers to a probability distribution of at least one performance metric associated with each of the one or more labor channels. In an embodiment, the distribution associated with a labor channel is determined based on the performance of the labor channels on execution of the tasks. In an embodiment, the performance of the labor channel is determined by determining a mean of the performances of the one or more workers in the labor channel.

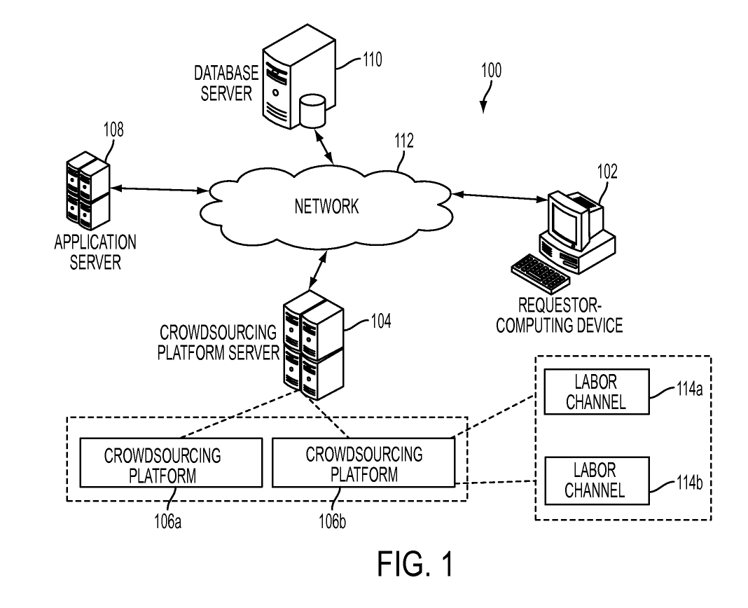

FIG. 1 is a block diagram illustrating a system environment 100 in which various embodiments may be implemented. The system environment 100 includes a requestor-computing device 102, a crowdsourcing platform server 104, an application server 108, a database server 110, and a network 112. Various devices in the system environment 100 (e.g., the requestor-computing device 102, the crowdsourcing platform server 104, the application server 108, and the database server 110) may be interconnected over the network 112.

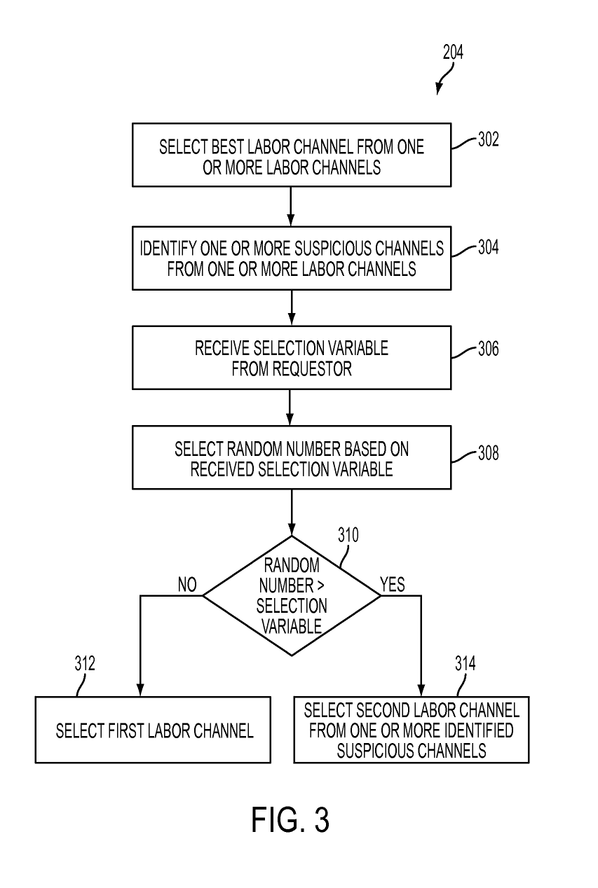

The requestor-computing device 102 may refer to a computing device, used by the requestor, to upload one or more tasks on the crowdsourcing platform server 104. In an embodiment, the requestor may further upload metadata associated with the one or more tasks on the crowdsourcing platform server 104. For example, if the crowdsourcing task corresponds to digitization of handwritten content, the requestor may provide electronic documents that include handwritten content as metadata. In an embodiment, the requestor may be presented with a user interface that enables the requestor to select a labor channel (e.g., 114a) for execution of the one or more tasks. The selection of the labor channel (e.g., 114a) by the requestor has been described later in conjunction with FIG. 3. The requestor-computing device 102 may realized through a variety of computing devices, such as a desktop, a computer server, a laptop, a personal digital assistant (PDA), a tablet computer, and the like.

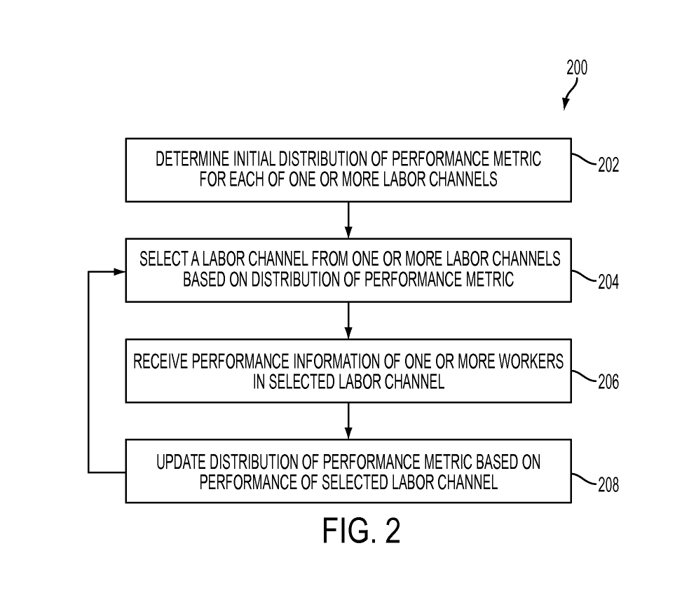

The crowdsourcing platform server 104 is configured to host one or more crowdsourcing platforms (e.g., crowdsourcing platform 106a and crowdsourcing platform 106b). Hereinafter, the crowdsourcing platform 106a and the crowdsourcing platform 106b, are collectively referred as crowdsourcing platforms 106. One or more crowdworkers are registered with the one or more crowdsourcing platforms 106. Further, the one or more crowdworkers are grouped in the one or more labor channels (e.g., labor channel 114a and labor channel 114b) based on at least the profile of the one or more crowdworkers. Hereinafter, the labor channel 114a and the labor channel 114b, are collectively referred as labor channels 114. The crowdsourcing platforms 106 may offer one or more tasks to the workers in the one or more labor channels 114. In an embodiment, the crowdsourcing platforms 106 presents a user interface to the one or more crowdworkers through a web-based interface or a client application. The one or more crowdworkers may access the one or more tasks through the web-based interface or the client application. Further, the one or more crowdworkers may submit a response to the crowdsourcing platforms 106 through the user interface. In an embodiment, the crowdsourcing platforms 106 may monitor the performance of the workers in the one or more labor channels 114. Based on the performance of the individual workers in a labor channel (e.g., 114a), the crowdsourcing platform server 104 may determine the performance of the labor channel (e.g., 114a). As discussed above, the performance of the one or more labor channels 114 may include a measure of one or more factors such as, but not limited to, accuracy, availability of the workers in the one or more labor channels, etc. In an embodiment, the crowdsourcing platforms 106 may store the performance of each of the one or more labor channels 114 in the database server 110. Based on the performance of the one or more labor channels 114, the crowdsourcing platforms 106 may reassign the one or more tasks to other labor channels (e.g., 114a or 114b) from the one or more labor channels 114. The switching between the labor channels 114 has been described later in conjunction with FIG. 2 and FIG. 3. In an embodiment, the crowdsourcing platform server 104 may be realized through an application server 108 such as, but not limited to, Java application server, .NET framework, and Base4 application server.

The application server 108 is configured to generate the one or more tasks for completion through crowdsourcing. In an embodiment, the requestor may upload the one or more tasks on the crowdsourcing platforms 106 through the application server 108. The application server 108 may receive the performance of the one or more labor channels 114 periodically. Based on the received performance, the application server 108 may determine the distribution of the performance metric associated with each of the one or more labor channels 114. Thereafter, the application server 108 may select a labor channel (e.g., 114a) from the one or more labor channels 114 for execution of the one or more tasks based on the determined distribution. In an embodiment, the application server 108 may transmit the selection information to the crowdsourcing platforms 106. The selection of the labor channel (e.g., 114a) has been described later in conjunction with FIG. 3. In an embodiment, the application server 108 may present information pertaining to the distribution of the performance metric associated with each of the one or more labor channels 114 to the requestor. Some examples of the application server 108 may include, but not limited to, a Java application server, a .NET framework, and a Base4 application server.

A person with ordinary skill in the art would understand that the scope of the disclosure is not limited to illustrating the application server 108 as a separate entity. In an embodiment, the functionality of the application server 108 may be implementable on/integrated with the crowdsourcing platform server 104.

The database server 110 may refer to a device or a computer that maintains a repository of the one or more tasks assigned to the one or more labor channels 114. Further, the database server 110 may store the profile information associated with each of the one or more workers. The database server 110 may further store the performance of the one or more labor channels 114 on the one or more tasks. The database server 110 may receive a query from the crowdsourcing platform server 104 and/or the application server 108 to retrieve the profile information associated with the one or more labor channels 114. For querying the database server 110, one or more querying languages may be utilized such as, but not limited to, SQL, QUEL, DMX and so forth. Further, the database server 110 may be realized through various technologies such as, but not limited to, Microsoft® SQL server, Oracle, and My SQL. In an embodiment, the crowdsourcing platform server 104 may connect to the database server 110 using one or more protocols such as, but not limited to, ODBC protocol and JDBC protocol.

It will be apparent to a person skilled in the art that the functionalities of the database server 110 may be incorporated into the crowdsourcing platform server 104 and/or the application server 108, without departing from the scope of the disclosure.

The network 112 corresponds to a medium through which content and messages flow between various devices of the system environment 100 (e.g. the requestor-computing device 102, the crowdsourcing platform server 104, the application server 108 and the database server 110). Examples of the network 112 may include, but are not limited to, a Wireless Fidelity (Wi-Fi) network, a Wide Area Network (WAN), a Local Area Network (LAN), or a Metropolitan Area Network (MAN). Various devices in the system environment 100 can connect to the network 112 in accordance with various wired and wireless communication protocols such as Transmission Control Protocol and Internet Protocol (TCP/IP), User Datagram Protocol (UDP), and 2G, 3G, or 4G communication protocols.

FIG. 2 is a flowchart 200 illustrating a method for assigning the one or more tasks to a labor channel (e.g., 114a), in accordance with at least one embodiment. The flowchart 200 is described in conjunction with FIG. 1.

At step 202, an initial distribution of a performance metric for each of the one or more labor channels 114 is determined. In an embodiment, the application server 108 determines the initial distribution. The initial distribution for the labor channel (e.g., 114a) is determined based on the performance of the labor channels 114 on the one or more tasks. Prior to determining the distribution, the application server 108 may receive an input from the requestor to select the performance metric from the one or more performance metrics. In an embodiment, the selected performance metric may be of importance to the requestor. For instance, if the requestor may want to receive the response of the one or more tasks as soon as possible, the requestor may select the response time as the performance metric. Similarly, if accuracy score is of importance to the requestor, the requestor may select the accuracy score as the performance metric. In an embodiment, the application server 108 may present an interface to the requestor through the requestor-computing device 102, which may enable the requestor to select the performance metric.

A person having ordinary skill in the art would appreciate that the scope of the disclosure is not limited to a selection of a single performance metric by the requestor. In an embodiment, the requestor may select more than one performance metrics without departing from the scope of the disclosure.

Post selecting the performance metric, the application server 108 may determine the distribution for each of the one or more labor channels 114 based on the performance of the respective labor channels on the selected performance metric. In an embodiment, the application server 108 may determine the distribution based at least on a previous performance of the one or more labor channels 114, performance of each of the one or more labor channels 114 on a set of sample tasks, or a random selection of a labor channel (e.g., 114a).

### Determining Distribution Through Sample Tasks

The application server 108 assigns one or more sample tasks to each labor channel 114. The workers in each labor channel 114 attempt the one or more sample tasks. The crowdsourcing platform server 104 monitors the performance of the workers in each labor channel 114. In an embodiment, the performance measure of workers in a labor channel (e.g., 114a) is reflective of the performance of the respective labor channel. In an embodiment, a mean of the performance of the workers may be considered as the performance of the respective labor channel. The crowdsourcing platform server 104 transmits the performance of each of the one or more labor channels 114 to the application server 108. The application server 108 determines the distribution for each of the one or more labor channels 114 based on the respective performance of the labor channels 114 on the one or more sample tasks. In an embodiment, the distribution so determined by the application server 108 is for the performance metric selected by the requestor.

In an embodiment, if a labor channel (e.g., 114a) has recorded a high performance on the set of sample tasks in comparison to the performance of the other labor channels, there is a high probability that the labor channel (e.g., 114a) may get selected for the execution of the one or more tasks. Therefore, the distribution for the labor channels 114 is reflective of a selection probability of the labor channels 114.

### Determining Distribution Through Historical Data

In an embodiment, the application server 108 extracts historical data pertaining to a set of tasks previously attempted by the workers in the respective labor channels, from the database server 110. Based on the historical data, the application server 108 may determine the performance of the workers in each labor channel 114. Thereafter, the application server 108 may determine the distribution of the performance metric for each of the one or more labor channels 114.

### Randomly Selecting Labor Channels

In an embodiment, the application server 108 randomly select a labor channel (e.g., 114a) and transmit one or more sample tasks to the selected labor channel (e.g., 114a). The application server 108 receives the performance measure of the randomly selected labor channel (e.g., 114a) from the crowdsourcing platform server 104. Based on the performance measure, the application server 108 determines the distribution of the performance metric associated with the randomly selected labor channel (e.g., 114a). In an embodiment, the process of randomly selecting the labor channel (e.g., 114a) is repeated for a predetermined number of times.

A person having ordinary skill in the art would understand that determining the distribution of the performance metric may involve determining a mean and a variance of the performance of the workers. Based on the mean and the variance, the application server 108 may determine the distribution of the performance metric.

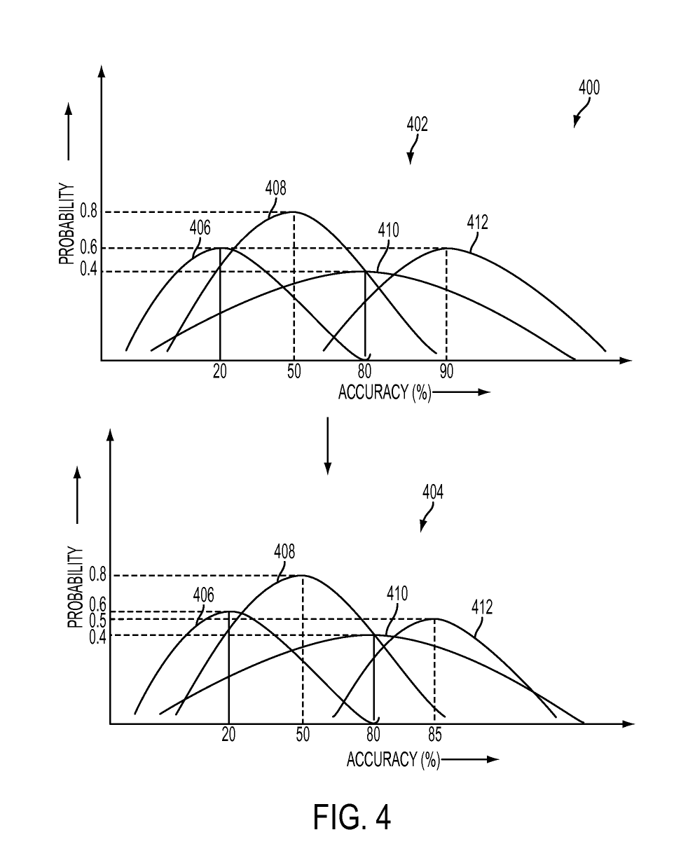

At step 204, a labor channel (e.g., 114a) from the one or more labor channels 114 is selected. In an embodiment, the application server 108 may select the labor channel (e.g., 114a) from the one or more labor channels 114. In an embodiment, the selected labor channel corresponds to a first labor channel. The labor channel (e.g., 114a) is selected based on the distribution of the performance of each of the one or more labor channels 114. For example, the probability of achieving 90% accuracy for labor channel-1 is 0.7 and that of the labor channel-2 is 0.4. Therefore, the application server 108 selects the labor channel-1. The selection of the labor channel (e.g., 114a) has been described later in conjunction with FIG. 4. In an embodiment, the application server 108 may transmit an information pertaining to the selected labor channel to the crowdsourcing platforms 106.

At step 206, a performance information of the one or more workers in the selected labor channel (e.g., 114a) on the one or more tasks is received. In an embodiment, the application server 108 may receive the performance data. In an embodiment, prior to receiving the performance information, the crowdsourcing platforms 106 may assign the one or more tasks to the selected labor channel (e.g., 114a). The workers in the selected labor channel (e.g., 114a) may attempt the one or more tasks. The crowdsourcing platforms 106 may monitor the performance of the workers on the one or more tasks. In an embodiment, the crowdsourcing platforms 106 may transmit such information related to the performance of the one or more workers to the application server 108. In an embodiment, the information related to the performance may include the performance of the selected labor channel (which is a mean of the performance of the workers in the selected labor channel). Table 1 provided below illustrates the performance information of the selected labor channel:

TABLE 1
Illustration of the mapping table to determine
performance of selected labor channel

| Labor channel | Response time | Accuracy |
|---|---|---|
| Labor channel -1 | 30 minutes | 0.6 |

As disclosed in Table 1, the application server 108 may receive performance information of the selected labor channel, in which average response time clocked by the workers in the selected labor channel is 30 minutes and the average accuracy of the workers is 0.6.

At step 208, the distribution of the performance metric for each of the one or more labor channels 114 is updated. In an embodiment, the application server 108 may update the distribution of the performance metric associated with each of the one or more labor channels 114. Based on the performance, the application server 108 updates the distribution of the performance metric for each of the one or more labor channels 114.

In an embodiment, the application server 108 determines a weight for each of the one or more labor channels 114 based on the performance of the first labor channel on the one or more tasks. Further, the application server 108 may utilize the weights to update the distribution associated with each of the one or more labor channels 114. In an embodiment, the sum of weights assigned to each of the one or more labor channels 114 is one.

For instance, if the workers in the first labor channel have recorded a high accuracy in attempting the one or more tasks, the application server 108 assigns a weight of 0.8 to the first labor channel. The remaining weight of 0.2 is distributed among remaining of the one or more labor channels. For example, if the number of remaining labor channels is 4, then each of the remaining labor channel gets a weightage of 0.05.

Based on the weightage assigned to each of the labor channels 114, the application server 108 may update the distribution of each of the one or more labor channels 114. In an embodiment, the application server 108 may vary one or more parameters associated with the distribution in order to update the distribution. In an embodiment, the one or more parameters may include, but are not limited to, a mean and a variance of the distribution. In an embodiment, the application server 108 may utilize the following equations to determine the updated mean for a labor channel (e.g., 114a) from the one or more labor channels 114 based on the weights:

\hat{μ}_{τ}_{ᵢ}=r˜Fᵢⁱ (1)

where,

i=index for i^{th} labor channel, iε[k];

k=number of labor channels;

\hat{μ}_{τ}_{ᵢ}: mean of the distribution of the i^{th} labor channel at time I;

r: weight assigned to the i^{th} labor channel; and

Fᵢⁱ=Performance Metric Function.

Thereafter, the application server 108 repeats the steps 204-208 periodically. In an embodiment, the application server 108 may evaluate the performance of the first labor channel after a predetermined time period. In an embodiment, the predetermined time period is provided by the requestor while transmitting the one or more tasks to the application server 108. The selection of the labor channel (e.g., 114a) has been described in conjunction with the FIG. 3.

As discussed above, the application server 108 monitors the performance of the workers in the one or more labor channels 114 periodically. Based on the performance of the one or more labor channels 114, the application server 108 may reassign the one or more tasks to other labor channel (e.g., 114a) from the one or more labor channels 114. For example, the application server 108 determines that the performance of the first labor channel has degraded. Further, a second labor channel from the one or more labor channels 114 has better accuracy than the first labor channel. In such a scenario, the application server 108 may reassign a sub set of tasks to the second labor channel. In an embodiment, the first labor channel may have completed work on a set of tasks from the one or more tasks. The application server 108 may not reassign such set of tasks to the second labor channel. In an embodiment, the application server 108 may reassign the un-attempted tasks to the second labor channel.

In an alternate embodiment, the application server 108 may determine tasks from the set of tasks for which correct responses are not received from the selected labor channel. The application server 108 may include such tasks in the subset of tasks for reassignment.

As discussed in FIG. 2 the first labor channel is selected based on the distribution of the performance metric associated with each of the one or more labor channels 114. Further, the distribution of each of the one or more labor channels 114 is updated based on the performance of the first labor channel on the one or more tasks. In a scenario, where the workers in the first labor channel keep on recording high accuracy score on the one or more tasks, the distribution of the performance metric of the labor channel will be such that other labor channel may not receive the one or more tasks. In such a scenario, the application server 108 may explore the other labor channels based on predetermined criteria. The exploration of the other labor channels has been described later in conjunction with FIG. 3.

FIG. 3 is a flowchart 204 illustrating a method of selecting a labor channel (e.g., 114a) from the one or more labor channels 114, in accordance with at least one embodiment. The flowchart 204 has been described in conjunction with FIG. 1 and FIG. 2.

At step 302, a best labor channel from the one or more labor channels 114 is selected. In an embodiment, the application server 108 selects the best labor channel. As discussed, the application server 108 receives an input from the requestor pertaining to the performance metric that is of importance to the requestor. Further, in an embodiment, the requestor may be asked to provide an input pertaining to the level or the value of the performance metric acceptable to the requestor. Based on the value acceptable to the requestor, the application server 108 may determine the labor channel (e.g., 114a). Thereafter, the application server 108 determines a probability of a labor channel (e.g., 114a) delivering the requested value acceptable to the requestor. For instance, the value of the accuracy acceptable to the requestor is 70%. The application server 108 may determine the probability that the labor channel-1 delivers 70% accuracy is 0.3 while that of labor channel-2 is 0.8. Thus, the application server 108 may select the labor channel-2 as the best labor channel.

At step 304, one or more suspicious channels from the one or more labor channels are identified. In an embodiment, the application server 108 identifies the one or more suspicious channels. In an embodiment, a suspicious channel corresponds to a labor channel that has either not been selected for a predetermined amount of time or the distribution of the performance metric of the suspicious channel is close to the distribution of the performance metric of the first labor channel in comparison to distribution of other labor channels. In an embodiment, the application server 108 may utilize the following equation to determine the suspicious channel:

$${s}_{i} = \{ \begin{matrix}1 & if {μ}^{*} - {\hat{μ}}_{i} \leq γ \sqrt{t - {τ}_{i}} \\ 0 & otherwise\end{matrix} \qquad ( 2 )$$

where,

sᵢ: corresponds to a suspicious labor channel;

μ*: Weight of the labor channel with maximum weight;

\hat{μ}ᵢ: Estimated weight of the i^{th} labor channel;

γ: User defined constant;

t: Current time instant; and

τᵢ: Time at which i^{th} labor channel was last selected.

In an embodiment, a degree of closeness between two labor channels is determined by the application server 108 by comparing the means of the distribution of the two labor channels. In an embodiment, if the difference between the mean of the distribution of the two labor channels is in a predetermined range, the distribution of the two labor channels are considered to be close.

At step 306, a selection variable is received from the requestor by the application server 108. In an embodiment, the selection variable corresponds to a probability of selecting a suspicious channel from the one or more suspicious channels. In an embodiment, the 1-(value of the selection variable), corresponds to a probability that the best labor channel is selected.

In an embodiment, the application server 108 may present a user interface to the requestor through the requestor-computing device 102. The user interface enables the requestor to input the value of the selection variable. In an embodiment, the value of the selection variable may lie in range of 0 and 1.

At step 308, a random number is selected. In an embodiment, the application server 108 selects the random number. In an embodiment, the range of the random number lies in between 0 and 1. In an alternate embodiment, the random number is selected based on the value of the selection variable.

At step 310, a check is performed to determine whether the value of the random number is less than the selection variable. In an embodiment, the application server 108 performs the check. If the application server 108 determines that the value of the random number is less than the selection variable, the application server 108 performs step 312.

At step 312, the application server 108 selects the first labor channel (as the first labor channel has the best performance).

However, if the application server 108 determines at step 310 that the value of the random number is greater than the selection variable, the application server 108 performs the step 314. At step 314, the application server 108 selects a second labor channel from the one or more identified suspicious channels. In an embodiment, the application server 108 selects the second labor channel randomly from the one or more suspicious channels.

In an embodiment, the probability of selecting either the first labor channel (or the best labor channel) or the second labor channel is depicted by following equation:

$${i}_{t} = \{ \begin{matrix}{i}^{*} & with probability 1 - ɛ \\ i s . t . {s}_{i} = 1 & with probability \frac{ɛ}{{\sum }_{i} {s}_{i} }\end{matrix} \qquad ( 3 )$$

Thereafter, the application server 108 repeats the steps 206-208 periodically to update the distribution of the performance metric associated with each of the one or more labor channels 114.

FIG. 4 is a flow diagram 400 illustrating an example of selecting a labor channel (e.g., 114a) from the one or more labor channels 114, in accordance with at least one embodiment. FIG. 4 has been explained in conjunction with the FIG. 2, and the FIG. 3. The flow diagram 400 includes a first graph 402 and a second graph 404. The first graph 402 illustrates a distribution of accuracy measure of the one or more labor channels 114. The second graph 404 illustrates an updated distribution for the one or more labor channels 114.

The first graph 402 depicts the probability distribution of the accuracy score for each of the one or more labor channels 114. For example, a first labor channel (exhibiting the distribution 406) has a maximum probability of 0.6 to deliver an accuracy of 20%. Similarly, a second labor channel (exhibiting the distribution 408) has a maximum probability of 0.8 to deliver an accuracy of 50%. A third labor channel has a maximum probability of 0.4 to deliver the accuracy of 80%. Finally, a fourth labor channel has the maximum probability of 0.6 to deliver the accuracy of 90%.

For instance, the application server 108 receives the input from the requestor that a minimum accuracy score of 85% is acceptable to the requestor. The application server 108 analyzes the distribution of the accuracy score for each of the one or more labor channels 114 to determine a probability of achieving the minimum accuracy score for each of the one or more labor channels 114. Following table illustrates probability for each of the one or more labor channels:

TABLE 2
Illustration of the probability for each
of the one or more labor channels

| Labor channel | Probability to achieve minimum accuracy score |
|---|---|
| Labor channel -1 | 0.05 |
| Labor channel -2 | 0.4 |
| Labor channel -3 | 0.05 |
| Labor channel -4 | 0.5 |

As disclosed in Table 2, the application server 108 may select a labor channel-4 for executing the one or more tasks. Alternatively, the application server 108 may select the one or more suspicious channels. As discussed above, the suspicious channels correspond to the labor channels that have distribution similar to the best labor channel and have not been used for executing the one or more tasks for a predetermined time period. As the labor channel-2 has the probability closes to the best labor channel (i.e., labor channel-4), the application server 108 may select the labor channel-2 as the suspicious channel.

As described in step 310, the application server 108 may either select the labor channel-2 (i.e., the suspicious channel) or the labor channel-4 (i.e., the best labor channel) for execution of the one or more tasks. Based on the performance of the selected labor channel, the distribution of the one or more labor channels 114 is modified.

The second graph 404 depicts modified updated distribution of the one or more labor channels 114. Considering that the best labor channel was selected by the application server 108 for executing the one or more tasks. Further considering, that the accuracy score recorded by the labor channel-4 is 85%. Thus, the application server 108 may modify the distribution as depicted in the second graph 404.

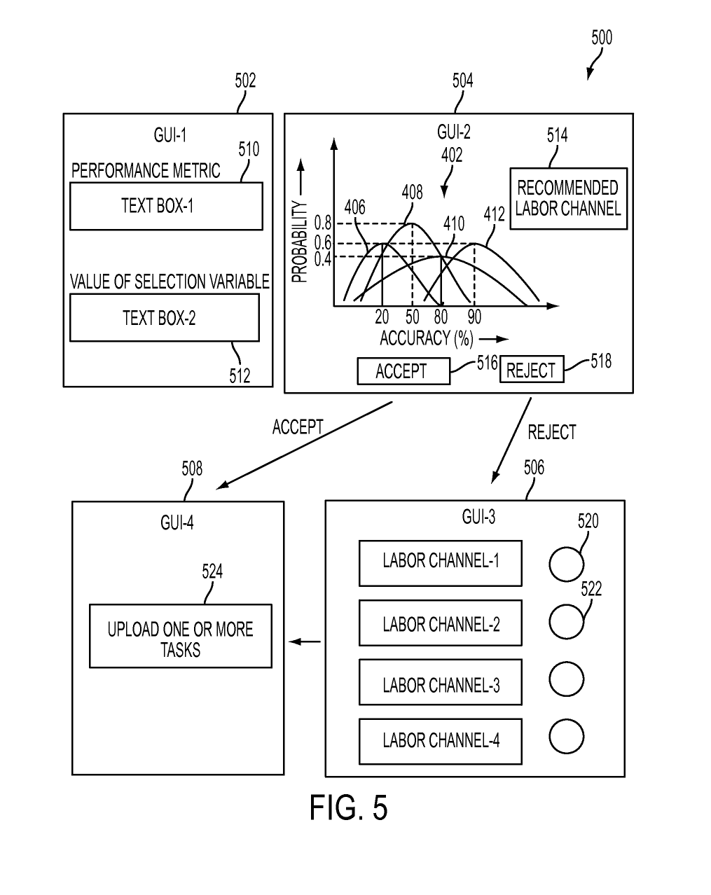

FIG. 5 is a block diagram illustrating a graphical user interface 500 presented to a requestor, in accordance with at least one embodiment. The block diagram 500 has been described in conjunction with FIG. 1, FIG. 2, and FIG. 3.

A graphical user interface-1, GUI-1, (depicted by 502) is presented to the requestor. The GUI-1 502 includes an input box-1 510 that enables the requestor enables the requestor to select a performance metric. In an embodiment, the input box-1 may be a drop down menu or a text box in which the requestor may input the performance metric that he/she wants to be considered. Further, the GUI-1 502 also enables the requestor to input the value of the selection variable.

Based on the selection of the performance metric 510 and the value of the selection variable 512, a graphical user interface-2, GUI-2, (depicted by 504) is presented to the requestor. The GUI-2 includes the first graph 402, as discussed in the FIG. 4. The GUI-2 further includes a region (depicted by 514) that shows a recommended labor channel, an accept button 516, and a reject button 518. Further, the GUI-2 504 enables the requestor either to accept (through the button 516) or to reject (through the button 518) the recommendation. If the requestor rejects the recommendation, a graphical user interface, GUI-3, (depicted by 506) is presented to the requestor. On the other hand, if the requestor accepts the recommendation, a graphical user interface, GUI-4, (depicted by 508) is presented to the requestor. The GUI-3 506 enables the requestor to select a labor channel (e.g. 520) from one or more labor channels (e.g., 520, and 522).

Based on the selection of the labor channel (e.g., 520), the one or more tasks are uploaded as depicted in GUI-4 508. In an embodiment, the application server 108 uploads the one or more tasks (depicted by 524) on the crowdsourcing platforms 106. The one or more tasks are presented to the selected labor channel for execution.

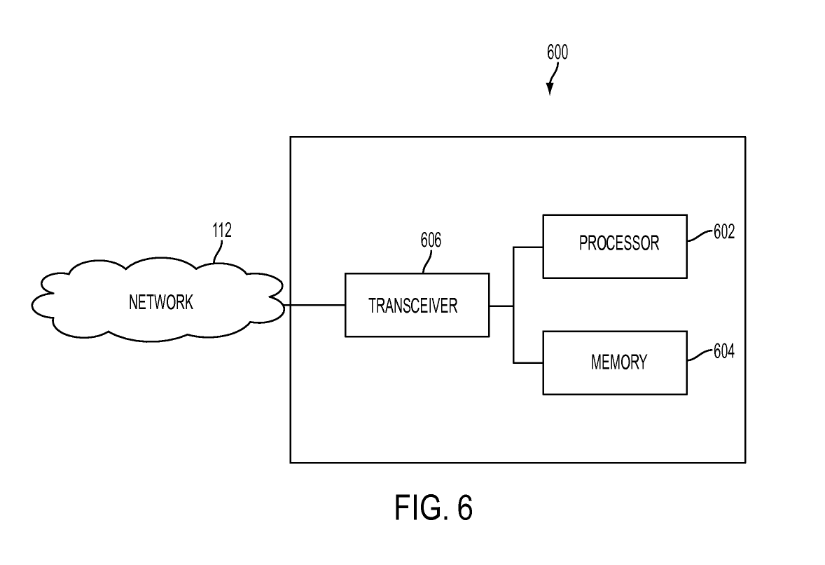

FIG. 6 is a block diagram illustrating an application server 108, in accordance with at least one embodiment. In an embodiment, the system 600 may correspond to the crowdsourcing platform server 104 or the application server 108. However, the scope of the disclosure should not be limited to the system 600 as the application server 108. In an embodiment, the system 600 can also be realized as the crowdsourcing platform server 104 without departing from the spirit of the disclosure.

The system 600 includes a processor 602, a memory 604, and a transceiver 606. The processor 602 is coupled to the memory 604 and the transceiver 606. The transceiver 606 may connect to the network 112.

The processor 602 includes suitable logic, circuitry, and/or interfaces that are operable to execute one or more instructions stored in the memory 604 to perform predetermined operations. The processor 602 may be implemented using one or more processor technologies known in the art. Examples of the processor 602 include, but are not limited to, an x86 processor, an ARM processor, a Reduced Instruction Set Computing (RISC) processor, an Application Specific Integrated Circuit (ASIC) processor, a Complex Instruction Set Computing (CISC) processor, or any other processor.

The memory 604 stores a set of instructions and data. Some of the commonly known memory implementations include, but are not limited to, a random access memory (RAM), a read only memory (ROM), a hard disk drive (HDD), and a secure digital (SD) card. Further, the memory 604 includes the one or more instructions that are executable by the processor 602 to perform specific operations. It is apparent to a person with ordinary skills in the art that the one or more instructions stored in the memory 604 enable the hardware of the system 600 to perform the predetermined operations.

The transceiver 606 transmits and receives messages and data to/from various components of the system environment 100 (e.g., the requestor-computing device 102, the crowdsourcing platform server 104, the application server 108 and the database server 110) over the network 112. Examples of the transceiver 606 may include, but are not limited to, an antenna, an Ethernet port, a USB port, or any other port that can be configured to receive and transmit data. The transceiver 606 transmits and receives data/messages in accordance with the various communication protocols, such as, TCP/IP, UDP, and 2G, 3G, or 4G communication protocols.

The disclosed embodiments encompass numerous advantages. Various embodiments of methods and systems for assigning one or more tasks to a labor channel from the one or more labor channels are disclosed. An advantage of the disclosure lies in fact that the requestors may get a chance to choose a labor channel from the one or more labor channels for the one or more tasks based on the distribution of the performance metric associated with each of the one or more labor channels. This kind of scenario may result in good performance of the labor channels. Further, this may also result in saving time and cost to the requestors. In addition, the crowdsourcing platform may also earn profit, and build reputation based on the performance of its labor channels. Further, the one or more labor channels are monitored periodically to update the distribution of the performance metric. Based on the updated distribution, the application server may reassign the one or more tasks to other labor channels having better performance than the previous labor channel (to which the one or more tasks have been assigned initially). This results is maintaining high performance and SLA associated with the one or more tasks.

The disclosed methods and systems, as illustrated in the ongoing description or any of its components, may be embodied in the form of a computer system. Typical examples of a computer system include a general purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or similar devices that enable the computer system to connect to databases and networks such as LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks such as steps that constitute the method of the disclosure. The systems and methods described can also be implemented using only software programming, only hardware, or a varying combination of the two techniques. The disclosure is independent of the programming language and the operating system used in the computers. The instructions for the disclosure can be written in all programming languages including, but not limited to, “C,” “C++,” “Visual C++,” and “Visual Basic”. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, with any product capable of implementing the above methods and systems, or the numerous possible variations thereof.

Various embodiments of the methods and systems for assigning a task to a labor channel has been disclosed. However, it should be apparent to those skilled in the art that modifications, in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art that are also intended to be encompassed by the following claims.

What is claimed is:

1. A method for assigning one or more tasks to a labor channel from one or more labor channels, said method comprising:
selecting, by one or more processors, a first labor channel from said one or more labor channels based at least on a distribution of a performance metric associated with each of said one or more labor channels, wherein said first labor channel is selected for execution of said one or more tasks;
updating, by said one or more processors, said distribution of said performance metric associated with each of said one or more labor channels based on performance of said first labor channel on execution of said one or more tasks;
selecting, by said one or more processors, a second labor channel from said one or more labor channels based at least on a method for assigning comparison between said updated distribution of said performance metric associated with said first labor channel, and said updated distribution of said performance metric associated with remaining one or more labor channels; and
assigning, by said one or more processors, said one or more tasks to said second labor channel.

2. The method of claim 1 further comprising presenting, by said one or more processors, information pertaining to said distribution of said performance metric associated with each of said one or more labor channels to requestors.

3. The method of claim 2 further comprising receiving input, by said one or more processors, from said requestors to select said second labor channel based on presentation of said information.

4. The method of claim 1, wherein said performance metric comprises at least one of a response time, accuracy, cost, number of active workers across spatio-temporal dimensions, or work history of workers.

5. The method of claim 1, wherein said distribution corresponds to a probability distribution of said performance metric associated with each of said one or more labor channels.

6. The method of claim 1, wherein said second labor channel is further selected based at least on a time elapsed since said second labor channel previously worked on said one or more tasks, and a random number.

7. The method of claim 1 further comprising assigning, by said one or more processors, one or more sample tasks to each of said one or more labor channels, to determine said distribution of said performance metric associated with each of said one or more labor channels.

8. The method of claim 1, wherein said labor channel corresponds to a group of workers, wherein said group of workers is formed based on profile of said workers.

9. The method of claim 8, wherein said profile comprises at least one of a worker's location, gender, age, or hobbies of said workers.

10. The method of claim 1, wherein said distribution associated with each of said one or more labor channels is updated periodically.

11. A system for assigning one or more tasks to a labor channel from one or more labor channels, said system comprising:
one or more processors operable to:
select a first labor channel from said one or more labor channels based at least on a distribution of a performance metric associated with each of said one or more labor channels, wherein said first labor channel is selected for execution of said one or more tasks;
update said distribution of said performance metric associated with each of said one or more labor channels based on performance of said first labor channel on execution of said one or more tasks;
select a second labor channel from said one or more labor channels based at least on a comparison between said updated distribution of said performance metric associated with said first labor channel, and said updated distribution of said performance metric associated with remaining one or more labor channels; and
assign said one or more tasks to said second labor channel.

12. The system of claim 11, wherein said one or more processors are further operable to present information pertaining to said distribution of said performance metric associated with each of said one or more labor channels to requestors.

13. The system of claim 11, said performance metric comprises at least one of a response time, accuracy, cost, number of active workers across spatio-temporal dimensions, or work history of workers.

14. The system of claim 11, wherein said distribution corresponds to a probability distribution of said performance metric associated with each of said one or more labor channels.

15. The system of claim 11, wherein said second labor channel is further selected based at least on a time elapsed since said second labor channel previously worked on said one or more tasks, and a random number.

16. The system of claim 11, wherein said one or more processors are further operable to assign one or more sample tasks to each of said one or more labor channels, to determine said distribution of said performance metric associated with each of said one or more labor channels.

17. The system of claim 11, wherein said labor channel corresponds to a group of workers, wherein said group of workers is formed based on profile of said workers.

18. The system of claim 17, wherein said profile comprises at least one of a worker's location, gender, age, or hobbies of said workers.

19. The system of claim 11, wherein said distribution associated with each of said one or more labor channels is updated periodically.

20. A computer program product for use with a computer, the computer program product comprising a non-transitory computer readable medium, wherein the non-transitory computer readable medium stores a computer program code for assigning one or more tasks to a labor channel from one or more labor channels, wherein the computer program code is executable by one or more processors to:
select a first labor channel from said one or more labor channels based at least on a distribution of a performance metric associated with each of said one or more labor channels, wherein said first labor channel is selected for execution of said one or more tasks;
update said distribution of said performance metric associated with each of said one or more labor channels based on performance of said first labor channel on execution of said one or more tasks;
select a second labor channel from said one or more labor channels based at least on a comparison between said updated distribution of said performance metric associated with said first labor channel, and said updated distribution of said performance metric associated with remaining one or more labor channels; and
assign said one or more tasks to said second labor channel.

21. A graphical user interface presented to a requestor, said graphical user interface comprising:
a first interface comprising:
a first input box enabling said requestor to select a performance metric of importance to said requestor;
a second input box enabling said requestor to input a value of a selection variable; and
a second interface comprising:
a first region configured to display a distribution of said selected performance metric for each of one or more labor channels;
a second region configured to display a recommended labor channel from said one or more labor channels;
an input button configured to receive first input from said requestor to at least accept or reject said recommended labor channel, wherein a third interface is displayed to said requestor based on said received first input; and
the third interface comprising:
a list of said one or more labor channels, wherein said requestor may provide second input to select a labor channel from said one or more labor channels.
